(19) United States
(12) Patent Application Publication
(10) Pub. No.: US 2013/0011714 A1
(43) Pub. Date: Jan. 10, 2013

(54) ELECTROCHEMICAL BATTERY AND METHOD OF PREPARING THE SAME

(76) Inventors: Dong-Hee Han, Yongin-si (KR); Hyun-Ki Park, Yongin-si (KR); Ju-Yong Kim, Yongin-si (KR); Jeong-Doo Yi, Yongin-si (KR)

(21) Appl. No.: 13/440,928

(22) Filed: Apr. 5, 2012

(30) Foreign Application Priority Data
Jul. 8, 2011 (KR) 10-2011-0067969

(51) Int. Cl. H01M 10/02; H01M 2/08; H01M 6/00; H01M 2/14

(52) U.S. Cl. 429/131; 29/623.1

(57) ABSTRACT

An electrochemical battery including: a housing; a pouch-shaped solid electrolyte disposed in the housing and having an open end; an insulator that is disposed on the open end of the solid electrolyte to cover the open end and includes a plurality of protrusions facing the open end of the solid electrolyte; at least two types of sealants disposed between the solid electrolyte and the insulator and having different glass transition temperatures, respectively; a first electrode material disposed inside the pouch-shaped solid electrolyte; and a second electrode material disposed outside the pouch-shaped solid electrolyte.

### CROSS-REFERENCE TO RELATED APPLICATION

This application claims priority to and the benefit of Korean Patent Application No. 10-2011-0067969, filed on Jul. 8, 2011, in the Korean Intellectual Property Office, the disclosure of which is incorporated herein in its entirety by reference.

### BACKGROUND

1. Field

One or more embodiments of the present invention relate to an electrochemical battery and a method of preparing the same.

2. Description of Related Art

Research into sodium-based electrochemical batteries for storing electric power generated for household use and electric power generated by photovoltaic power generation and wind power generation and for supplying electric power to electric vehicles is continuing.

Sodium-based electrochemical batteries, such as sodium-nickel chloride batteries or sodium sulfur (NaS) batteries, are large-capacity batteries that store a few kW to a few MW of electric power and have high energy density and a long lifetime. Due to these characteristics, they are used in a wide range of applications.

A standard reduction potential of sodium is 2.71 V in a sodium-based battery that is one of electrochemical batteries. Since a cell voltage higher than 2 V can be obtained, sodium has been widely used as a material for forming a negative electrode. Furthermore, on average, the Earth's crust contains about 2.63% sodium. Thus, sodium is an inexpensive mineral found in large natural deposits. Sulfur is also an inexpensive mineral, found in large natural deposits. Thus, if sodium and sulfur are used to form electrodes of a battery, battery manufacturing costs may be reduced. Particularly, the manufacturing costs for the sodium/sulfur battery are less than those for comparable lithium/sulfur batteries.

Since sodium β-alumina electrolyte that has high sodium-ion conductivity was developed by Ford Motor Company (U.S.A.) in 1967, much research into this electrolyte has been conducted. However, electrolytes are required to be maintained at a temperature greater than 300° C. in order to have high conductivity of sodium ions. However, a sodium negative electrode and a sulfur positive electrode exist in liquid phase at 300° C. and are highly reactive and explosive

### SUMMARY

One or more aspects of embodiments of the present invention are directed toward an electrochemical battery including at least two types of sealants disposed between an insulator and a solid electrolyte and having different glass transition temperatures (Tg), respectively.

One or more aspects of embodiments of the present invention are directed toward a method of preparing the electrochemical battery.

Additional aspects will be set forth in part in the description which follows and, in part, will be apparent from the description, or may be learned by practice of the presented embodiments.

According to one or more embodiments of the present invention, an electrochemical battery includes: a housing; a pouch-shaped solid electrolyte disposed in the housing and having an open end; an insulator that is disposed on the open end of the solid electrolyte to cover the open end and includes a plurality of protrusions facing the open end of the solid electrolyte; at least two types of sealants disposed between the solid electrolyte and the insulator and having different glass transition temperatures, respectively; a first electrode material disposed inside the pouch-shaped solid electrolyte; and a second electrode material disposed outside the pouch-shaped solid electrolyte.

According to one or more embodiments of the present invention, a method of preparing an electrochemical battery includes: disposing at least two types of sealants having different glass transition temperatures, respectively, between the solid electrolyte and the insulator; and heat-treating the sealants.

### BRIEF DESCRIPTION OF THE DRAWINGS

These and/or other aspects will become apparent and more readily appreciated from the following description of the embodiments, taken in conjunction with the accompanying drawings of which:

FIG. 1 is a schematic vertical cross-sectional view of a comparable sodium sulfur (NaS) battery;

FIG. 2 is a schematic vertical cross-sectional view of an electrochemical battery according to an embodiment of the present invention;

FIGS. 3 to 6 are schematic partial vertical cross-sectional views of an electrochemical battery according to another embodiment of the present invention;

FIG. 7 is a diagram for describing a principle of charging and discharging of a sodium sulfur battery according to an embodiment of the present invention;

FIG. 8 is an optical microscopic image showing air tightness of a second sealant 60b according to Comparative Example 1; and

FIG. 9 is an optical microscopic image showing air tightness of a second sealant 60b according to Example 1.

### DETAILED DESCRIPTION

Reference will now be made in detail to embodiments, examples of which are illustrated in the accompanying drawings, wherein like reference numerals refer to the like elements throughout. In this regard, the present embodiments may have different forms and should not be construed as being limited to the descriptions set forth herein. Accordingly, the embodiments are merely described below, by referring to the figures, to explain aspects of the present description.

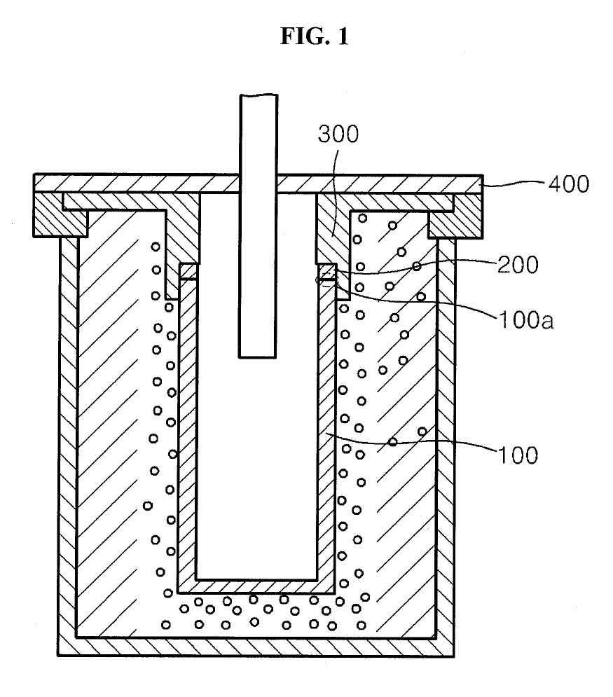

FIG. 1 is a schematic vertical cross-sectional view of a comparable sodium sulfur (NaS) battery.

Referring to FIG. 1, an insulating material and a plate are stacked on an open end of a pouch-shaped solid electrolyte 100, and a sealant 200 formed of a glass material is interposed between an upper surface 100a of the open end of the solid electrolyte 100 and the insulator 300. However, the glass material is corroded by an alkali metal while the battery is working, thereby reducing lifetime of the battery. Since the thickness of the solid electrolyte 100 is less than 2 mm, the sealant 200 disposed on the upper surface 100a of the open end of the solid electrolyte 100 cannot have a large cross-section. Thus, it is difficult to obtain sufficient binding force between the insulator 300 and the solid electrolyte 100.

As such, since the above comparable sodium/sulfur battery has a structure shown in FIG. 1, the battery may corrode and have poor binding force and low safety.

Furthermore, the glass sealant used in the electrochemical battery corrodes by an alkali metal and has poor adhesive strength, and thus lifetime of the battery may decrease.

An electrochemical battery and a method of preparing the same according to embodiments of the present invention will be described in detail with reference to the accompanying drawings.

An electrochemical battery according to an embodiment of the present invention includes: a housing; a pouch-shaped solid electrolyte disposed in the housing and having an open end; an insulator that is disposed on the open end of the solid electrolyte to cover the open end and includes a plurality of protrusions facing the open end of the solid electrolyte; at least two types of sealants having different glass transition temperatures (Tg), respectively, and disposed between the solid electrolyte and the insulator; a first electrode material disposed inside the pouch-shaped solid electrolyte; and a second electrode material disposed outside the pouch-shaped solid electrolyte.

The insulator may include a plurality of protrusions spaced apart from the edge of the housing or a plurality of protrusions extending from the edge of the housing.

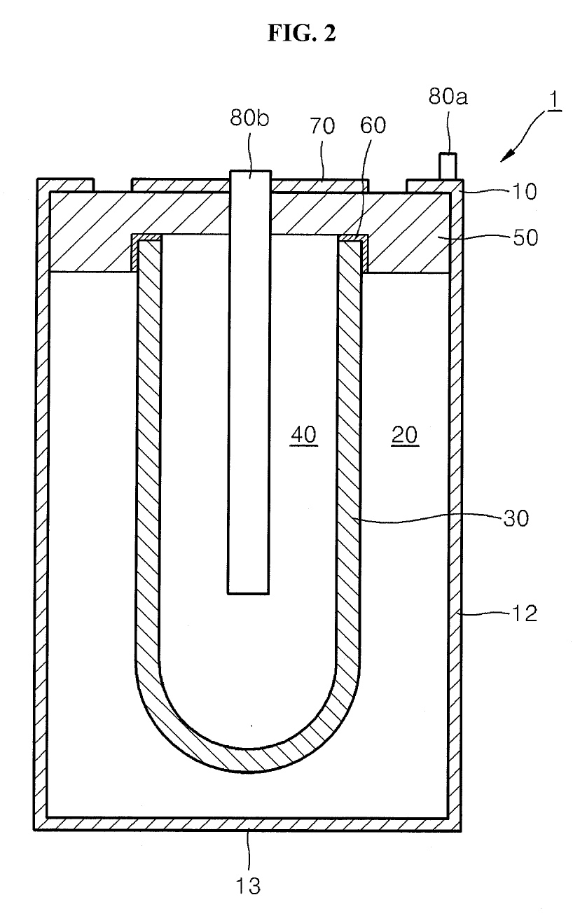

FIG. 2 is a schematic vertical cross-sectional view of an electrochemical battery according to an embodiment of the present invention.

Referring to FIG. 2, an electrochemical battery 1 includes a housing 10, a pouch-shaped solid electrolyte 30 that is disposed in the housing 10, has one open end, and partitions inner space of the housing 10 into a first electrode chamber 20 and a second electrode chamber 40, and an insulator 50 that is stacked on the open end of the solid electrolyte 30, wherein the solid electrolyte 30 and the insulator 50 are sealed by a sealant 60.

The first electrode chamber 20 partitioned by the solid electrolyte 30 includes a first electrode material, and the second electrode chamber 40 includes a second electrode material. The first electrode chamber 20 and the second electrode chamber 40 may respectively function as a positive electrode chamber or a negative electrode chamber according to the types of the first electrode material and the second electrode material.

The housing 10 may have a rectangular horizontal cross-section and a long pouch-shaped vertical cross-section, but the shape of the housing 10 is not limited thereto. The housing 10 may include side walls 12 extending in a vertical direction and a lower wall 13 bent perpendicularly to the side walls 12.

The current collector 80 has a first current collector 80a and a second current collector 80b. An upper wall of the housing 10 is partially open to externally expose the first current collector 80a extending from the first electrode chamber 20. Alternatively, the second current collector 80b may extend to the inside of the solid electrolyte 30 via a through hole of a ring-shaped insulator 50. The first current collector 80a and the second current collector 80b may respectively be used as a positive current collector or a negative current collector according to the materials filled in the first electrode chamber 20 and the second electrode chamber 40.

A cross-section of the housing 10 may have various suitable shapes such as a polygon, e.g., a rectangle, a circle, etc. and may have various suitable sizes. The housing 10 may be formed of a metal such as nickel (Ni) or mild steel, but is not limited thereto. The housing 10 may function as a current collector.

The solid electrolyte 30 is accommodated in the housing 10 and partitions the housing 10 into the first electrode chamber 20 and the second electrode chamber 40 disposed in the first electrode chamber 20. The solid electrolyte 30 has a pouch-shape, but is not limited thereto. When the solid electrolyte 30 has a pouch-shape, a portion that is open and adjacent to the insulator 50 is referred to as an open end (open portion) of the solid electrolyte 30 and a portion that is disposed close to the bottom of the housing 10 is referred to as a lower portion of the solid electrolyte 30. The lower portion of the solid electrolyte 30 is spaced apart from the bottom of the housing 10 by a set or predetermined distance. The open end of the solid electrolyte 30 may have a first surface and a second surface that is in contact with the first surface and makes an angle with the first surface. The insulator 50 is stacked on the open end of the solid electrolyte 30, and the space between the solid electrolyte 30 and the insulator 50 is sealed by the sealant 60. In particular, the space between the first surface of the open end of the solid electrolyte 30 and the insulator 50 is filled by the sealant 60. Alternatively, the space between the first surface and the second surface of the open end of the solid electrolyte 30, which is in contact with the first surface, and the insulator 50 is filled by the sealant 60. For example, the first surface of the open end of the solid electrolyte 30 may be an upper side of the open end and the second surface of the open end of the solid electrolyte 30 may be an outer side or inner side (right or left side) of the open end.

The first electrode chamber 20 is disposed outside the solid electrolyte 30, i.e., between the housing 10 and the solid electrolyte 30, and includes the first electrode material. The second electrode chamber 40 is disposed inside the solid electrolyte 30, i.e., between the second current collector 80b and solid electrolyte, and includes the second electrode material. The first electrode chamber 20 and the second electrode chamber 40 may respectively be used as a positive electrode chamber or a negative electrode chamber according to the material filled in the first electrode chamber 20 and the second electrode chamber 40.

For example, when a negative electrode material, i.e., alkali metal such as sodium (Na), lithium (Li), or potassium (K), is used, the first electrode chamber 20 or the second electrode chamber 40 may function as the negative electrode chamber. When a positive electrode material, i.e., sulfur (S), nickel (Ni), cobalt (Co), zinc (Zn), chromium (Cr), iron (Fe), NiCl₂, or FeS is used, the first electrode chamber 20 or the second electrode chamber 40 may function as the positive electrode chamber.

When sodium is used as the negative electrode material, sodium exists in a molten (melted) state as a liquid. When sulfur is used as the positive electrode material, high-purity sulfur may be impregnated in carbon felt. In addition, the positive electrode chamber may further include a liquid electrolyte such as NaAlCl₄ in addition to the positive electrode material.

For example, when a transition metal such as nickel (Ni), cobalt (Co), zinc (Zn), chromium (Cr), or iron (Fe) is used as the positive electrode material, the positive electrode material produces TCl₂ during charging. In this regard, Cl indicates chloride of the electrolyte, and T indicates a transition metal. When a transition metal is used as the positive electrode material, the liquid electrolyte may be NaAlCl₄. NaAlCl₄ may be formed of an equimolar mixture of sodium chloride (NaCl) and aluminum chloride (AlCl₃). The liquid electrolyte may exist in a molten (melted) state at an operation temperature of the electrochemical battery.

A secondary battery using sodium in the negative electrode is a sodium secondary battery. In particular, a secondary battery using sodium in the negative electrode and sulfur in the positive electrode is a sodium sulfur battery, and a secondary battery using sodium in the negative electrode and nickel in the positive electrode is a sodium-nickel chloride battery. The sodium sulfur battery and the sodium-nickel chloride battery are examples of the electrochemical battery according to an embodiment of the present invention. However, the electrochemical battery is not limited thereto.

The solid electrolyte 30 may be ion-permeable. Alkali ions, e.g., sodium ions, generated during charging and discharging may move from the first electrode chamber 20 to the second electrode chamber 40 or from the second electrode chamber 40 to the first electrode chamber 20 via the solid electrolyte 30. The solid electrolyte 30 may have a pouch-shape, one end of which is open and may be disposed within the housing 10.

The solid electrolyte 30 may include a β-alumina-based material. For example, the solid electrolyte 30 may include β-alumina or β″-alumina. The solid electrolyte 30 may overall include β-alumina or β″-alumina and may be connected to the insulator 50 via the sealant 60.

The insulator 50 and a metal plate 70 that is connected to the second current collector (or second electrode) 80b are disposed on the open end of the solid electrolyte 30, and the metal plate 70 extends the second current collector (or second electrode) 80b and firmly fix the second current collector 80b to the insulator 50.

The insulator 50 is disposed to cover the open end of the solid electrolyte 30 and includes a plurality of protrusions facing the open end of the solid electrolyte 30. For example, the insulator 50 includes a main body and protrusions protruding from the main body. The insulator 50 may be disposed between the plate 70 and the open end of the solid electrolyte 30. For example, as shown in FIG. 2, the insulator 50 includes a protrusion to face the open end of the solid electrolyte 30, the protrusion of the insulator 50 may extend to a side wall (or edge) 12 of the housing 10 or may extend to a certain point that is spaced apart from the side wall (or edge) 12 of the housing 10. The insulator 50 may be sealed by the sealant 60 in company with the solid electrolyte 30. The insulator 50 includes one surface and another surface that makes an angle with the one surface and is sealed by the sealant 60 in company with the solid electrolyte 30.

The sealant 60 may include at least two types of sealants having different glass transition temperatures (Tg), respectively, and disposed between the solid electrolyte 30 and the insulator 50.

The sealant 60 may be disposed between the first surface of the solid electrolyte 30 and the one surface of the insulator 50 and between the second surface of the solid electrolyte 30 which makes an angle with the first surface thereof and the other surface of the insulator 50.

As another example, the first surface of the solid electrolyte 30 may be in contact with the one surface of the insulator 50, and the sealant 60 may be disposed between the second surface of the solid electrolyte 30, which makes an angle with the first surface, and the other surface of the insulator 50.

The open end of the solid electrolyte 30 may include the first surface and the second surface which makes an angle with the first surface. The first surface may be referred to as an upper or first surface 30c of the solid electrolyte 30, and the second surface includes an outer surface 30a and/or an inner or second surface 30b. The outer surface 30a of the solid electrolyte is close to (is facing) the first electrode chamber 20 and the inner surface 30b of the solid electrolyte 30 is close to (is facing) the second electrode chamber 40. The second surface of the solid electrolyte 30 includes the outer surface or the inner surface, or both the outer surface and the inner surface.

The insulator 50 includes a main body and a plurality of protrusions extending from the main body. One surface of the protrusion includes an outer surface 50a that is close to (is facing) the side wall 12 of the housing 10 and an inner surface 50b that is close to (is facing) the second current collector 80b and is connected to one surface 50c of the main body.

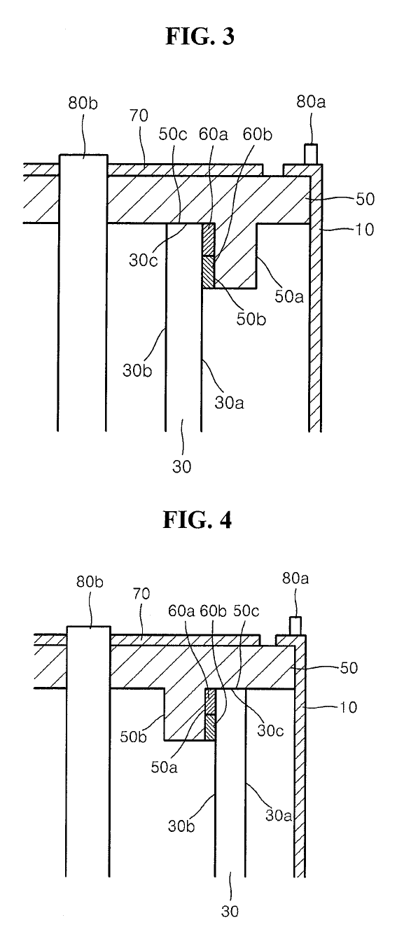

For example, according to an embodiment of the present invention, as shown in FIG. 3, the first surface or upper surface 30c of the open end of the solid electrolyte 30 is in contact with the one surface 50c of the insulator 50. The sealant 60 including a first sealant 60a and a second sealant 60b which have different glass transition temperatures (Tg), respectively, may be filled in space between the second surface 30b of the solid electrolyte 30, which is in contact with the upper or first surface 30c and making an angle with the first surface 30c (i.e., the inner surface of the solid electrolyte 30), and the inner surface 50b of the protrusion of the insulator 50.

As shown in FIG. 3, the first sealant 60a, having a lower transition temperature (Tg) than the second sealant 60b, may be stacked on the second sealant 60b to improve air tightness.

According to another embodiment of the present invention, as shown in FIG. 4, the upper or first surface 30c of the open end of the solid electrolyte 30 is in contact with the one surface 50c of the insulator 50. The sealant 60 including a first sealant 60a and a second sealant 60b which have different Tg may be filled in space between the second surface 30b, which is in contact with the first surface 30c and makes an angle with the first surface 30c (i.e., the inner surface of the solid electrolyte 30), and the outer surface 50a of the protrusion of the insulator 50. As shown in FIG. 4, the first sealant 60a having a lower glass transition temperature (Tg) than the second sealant 60b may be stacked on the second sealant 60b to improve air tightness.

According to another embodiment of the present invention, as shown in FIG. 5, the protrusion of insulator 50 is disposed between the side wall 12 of the housing 10 and the solid electrolyte 30. The sealant 60 including the first sealant 60a and the second sealant 60b having different glass transition temperatures (Tg), respectively, may be disposed in the space surrounded by the first surface of the solid electrolyte 30, the second surface thereof making an angle with the first surface, the one surface of the insulator 50 and the other surface thereof making an angle with the one surface. For example, the sealant 60 may be disposed in the space surrounded by the outer surface 30a of the solid electrolyte 30, the first or upper surface 30c of the solid electrolyte 30, the inner surface 50b of the protrusion of the insulator 50, and the one surface 50c of the main body of the protrusion adjacent to the inner surface 50b. As shown in FIG. 5, the first sealant 60a having a lower glass transition temperature (Tg) than the second sealant 60b may be stacked on the second sealant 60b to improve air tightness.

According to another embodiment of the present invention, as shown in FIG. 6, the protrusion of insulator 50 is spaced apart from the side wall of the housing 10 and disposed between the inner surface of the solid electrolyte 30 and a second current collector 80b. The sealant 60 including the first sealant 60a and the second sealant 60b having different glass transition temperatures (Tg), respectively, may be disposed in the space surrounded by the first surface of the solid electrolyte 30, the second surface thereof making an angle with the first surface, the one surface of the insulator 50, and the other surface thereof making an angle with the one surface. That is, the sealant 60 may be disposed in the space surrounded by the inner surface 30b of the solid electrolyte 30, the upper surface 30c of the solid electrolyte 30 which is adjacent to the inner surface 30b, the outer surface 50a of the protrusion of the insulator 50, and the one surface 50c of the main body of the protrusion adjacent to the outer surface 50a. As shown in FIG. 6, the first sealant 60a having a lower glass transition temperature (Tg) than the second sealant 60b may be stacked on the second sealant 60b to improve air tightness.

The negative electrode chamber generally includes a melted alkali metal, resulting in corrosion. Thus, the sealant 60 disposed as described above may be disposed in the positive electrode chamber. However, the present invention is not limited thereto.

The thickness of the sealant 60 may be in the range of 20 μm to 700 μm, for example, 100 μm to 300 μm. In one embodiment, when the thickness of the sealant 60 is within the range described above, adhesive strength is sufficient and unnecessary space is reduced.

The sealant 60 may include a plurality of sealants having different glass transition temperatures (Tg), respectively, or different softening points, respectively. For example, the sealant 60 may include at least two types of sealants having different Tg, such as a first sealant 60a and a second sealant having a higher Tg than the first sealant 60a. The first sealant 60a may have a glass transition temperature (Tg) lower than that of the second sealant 60b and may be disposed on the second sealant 60b. The difference of the glass transition temperature (Tg) or softening point therebetween may be in the range of 50 to 250° C. For example, if the Tg of the first sealant 60a is 300° C., the glass transition temperature (Tg) of the second sealant 60b is 350° C. In one embodiment, when the insulator 50 and the solid electrolyte 30 are sealed by heat-treatment at a temperature within the range described above, air tightness is improved.

The glass transition temperature (Tg) of the first sealant 60a may be in the range of 300 to 550° C., for example, 400 to 500° C., and the glass transition temperature (Tg) of the second sealant 60b may be in the range of 350 to 800° C., for example, 650 to 750° C. In one embodiment, if the glass transition temperatures (Tg) of the first sealant 60a and the second sealant 60b are within the ranges described above, adhesive strength and air tightness of the sealant 60 between the insulator 50 and the solid electrolyte 30 are improved.

When the first sealant 60a having a lower glass transition temperature (Tg) (or a softening point) than the second sealant 60b is stacked on the second sealant 60b, the first sealant 60a is melted at a lower temperature before the second sealant 60b is melted during the heat-treatment. Thus, the first sealant 60a flows into pores of the second sealant 60b, space between the second sealant 60b and the inner or outer surface of the solid electrolyte 30, or space between the second sealant 60b and the inner or outer surface of the insulator 50 to improve air tightness. Since the second sealant 60b has a higher Tg or softening point than the first sealant 60a, it is less deformed at a temperature where the first sealant 60a is melted. In other words, although the first sealant 60a having higher fluidity than the second sealant 60b is melted, the shape of the second sealant 60b remains in good condition and maintains excellent air tightness. Since the sealant 60 is filled in the space surrounded by the inner and outer surfaces of the solid electrolyte 30 and one side of the insulator 50, the adhered area increases, thereby improving adhesive strength.

The first sealant 60a may include a Bi₂O₃—ZnO—B₂O₃—SiO₂ oxide. When the first sealant 60a includes the above component, the glass transition temperature (Tg) of the first sealant 60a may be within the range described above.

In the first sealant 60a, the content of Bi₂O₃ may be in the range of 10 to 75 parts by weight, for example, 30 to 40 parts by weight, based on 100 parts by weight of SiO₂.

In the first sealant 60a, the content of ZnO may be in the range of 5 to 50 parts by weight, for example, 30 to 40 parts by weight, based on 100 parts by weight of SiO₂.

In the first sealant 60a, the content of B₂O₃ may be in the range of 10 to 40 parts by weight based on 100 parts by weight of SiO₂.

When the contents of the components of the first sealant 60a are within the ranges described above, the first sealant 60a has a glass transition temperature (Tg) range described above. Thus, in one embodiment, when the first sealant 60a is used with the second sealant 60b, air tightness and adhesive strength are improved.

The second sealant 60b may include a SiO₂—CaO—Al₂O₃—B₂O₃ oxide. When the second sealant 60b includes the above component, the glass transition temperature (Tg) of the first sealant 60a may be within the range described above.

In the second sealant 60, the content of CaO may be in the range of 5 to 25 parts by weight, for example, 10 to 20 parts by weight, based on 100 parts by weight of SiO₂.

In the second sealant 60b, the content of Al₂O₃ may be in the range of 5 to 75 parts by weight, for example, 40 to 50 parts by weight, based on 100 parts by weight of SiO₂.

In the second sealant 60, the content of B₂O₃ may be in the range of 25 to 100 parts by weight, for example, 50 to 70 parts by weight, based on 100 parts by weight of SiO₂.

When the contents of the components of the second sealant 60b are within the ranges described above, the first sealant 60a has a glass transition temperature (Tg) range described above. Thus, when the first sealant 60a is used with the second sealant 60b, air tightness and adhesive strength may be improved.

A method of preparing an electrochemical battery according to another embodiment of the present invention includes: disposing at least two types of sealants having different glass transition temperatures (Tg), respectively, between a solid electrolyte and an insulator; and heat-treating the sealants.

The alignment of the sealant 60 is described above, but is not limited thereto.

The method may further include preparing the first sealant 60a and the second sealant 60b before the disposing of the at least two types of sealants having the different glass transition temperatures (Tg), respectively, between the solid electrolyte 30 and the insulator 50.

The first sealant 60a is prepared by dissolving a material in a powder form including Bi₂O₃, ZnO, B₂O₃ and SiO₂ in a mixture of a solvent and a binder and stirring the mixture, resulting in a first composition in the form of a slurry or paste. The solvent may be selected from the group consisting of butyl carbitol, butyl carbitol acetate, terpineol, ethyl carbitol, ethyl carbitol acetate, and texanol. The binder may be selected from the group consisting of ethyl cellulose, acryl binder, and nitro cellulose.

The second sealant 60b is prepared by dissolving a material in a powder form including SiO₂, CaO, Al₂O₃ and B₂O₃ in a mixture of a solvent and a binder and stirring the mixture, resulting in a second composition in the form of a slurry or paste. The solvent and the binder used to prepare the second composition are the same as those used in the preparation of the first composition.

The slurry or paste of the first composition and the second composition are disposed between the first surface of the solid electrolyte 30 and one surface of the insulator 50, and between the second surface of the solid electrolyte 30 which is adjacent to and making an angle with the first surface and the other surface of the insulator 50. Then, a plate is disposed on the solid electrolyte 30 and heat-treated under atmospheric conditions to melt the first sealant 60a and the second sealant 60b, resulting in sealing the solid electrolyte 30 and the insulator 50. The heat-treatment may be performed at a temperature ranging from 300 to 1000° C., for example, 450 to 800° C. Alternatively, the heat-treatment may be performed at a temperature where the first sealant 60a is melted and the shape of the second sealant 60b remains. When the heat-treatment is performed in the temperature range described above, the first sealant 60a is melted before the second sealant 60b is melted, so that the melted first sealant 60a flows into pores of the second sealant 60b, empty space, space between one side of the solid electrolyte 30 and the second sealant 60b, or space between one side of the insulator 50 and the second sealant 60b, and then the second sealant 60b is melted. Thus, air tightness and adhesive strength of the sealant 60 (including the first and second sealants 60a and 60b) are improved.

The above-described electrochemical battery is a secondary battery that is rechargeable and dischargeable, and reactions during charging and discharging operations will now be described briefly. In the charging and discharging operations, the negative electrode material is sodium, and the positive electrode material is sulfur. Here, an electrochemical battery including β-alumina as the solid electrolyte 30, i.e., a sodium-sulfur battery, is described, but the present invention is not limited thereto.

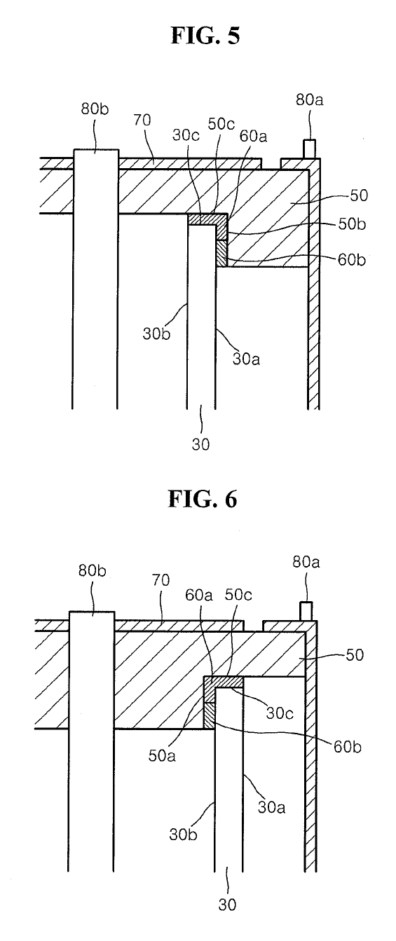

FIG. 7 is a diagram for describing a principle of charging and discharging of a sodium sulfur battery according to an embodiment of the present invention.

During discharging, sodium liberates electrons to become sodium ion. The sodium ion passes through β-alumina to move toward the positive electrode and is involved in reaction with sulfur and electrons to form a sodium sulfur-based compound.

Reaction performed in the positive electrode is shown in formula 1 below, reaction performed in the negative electrode is shown in formula 2 below, and the overall reaction is shown in formula 3 below.

Positive electrode: xS+2e− [symbol] Sₓ²⁺ (1)

Negative electrode: 2Na [symbol] 2Na⁺+2e⁻ (2)

Overall reaction: 2Na+xS [symbol] Na₂Sₓ (3)

The sodium battery having the above-described mechanism will be briefly described. The electrolyte of the sodium sulfur battery has excellent ionic conductivity, and low electrical conductivity close to zero (0), high chemical resistance, opaqueness, and suitable mechanical strength. Examples of the material satisfying the above-described conditions include borate glass, β-alumina, and nasicon, and β-alumina is suitable in consideration of ionic conductivity and commercial processability. β-alumina and β″-alumina have different crystallographical structure although they have the same chemical formula. An electrolyte used in a sodium sulfur battery generally indicates β″-alumina.

A sodium electrode is used as the negative electrode and may be disposed within the battery. As reaction proceeds in the battery, the content of sodium decreases in the sodium electrode, and the sodium moves toward the sulfur electrode. Accordingly, a device that prevents performance reduction of the battery during the discharging by uniformly maintaining the area of the sodium electrode that is in contact with the electrolyte should be provided. For example, a capillary action may be used by disposing a wick on the electrolyte, or a sodium azide may be used in order to apply a pressure by a nitrogen gas for uniformly maintaining liquid sodium on the surface of the electrolyte. However, the present invention is not limited thereto.

In general, a sulfur electrode is used as the positive electrode. However, the present invention is not limited thereto. The sulfur electrode may be prepared by impregnating high-purity sulfur in carbon felt.

The present invention will now be described in further detail with reference to the following examples. However, these examples are not intended to limit the scope of the one or more embodiments of the present invention.

### Example 1

1.5 g of ethyl cellulose was dissolved in 24 g of butyl carbitol that is a solvent, and 44 g of Bi₂O₃—ZnO—B₂O₃—SiO₂ powder having a Tg of 441° C. (softening point Tdsp: 485° C.) was added thereto. Then, the mixture was stirred to prepare a first sealant 60a in the form of a slurry (or paste).

1.5 g of ethyl cellulose was dissolved in 24 g of butyl carbitol that is a solvent, and 44 g of SiO₂—CaO—Al₂O₃—B₂O₃ powder having a Tg of 671° C. (softening point Tdsp: 795° C.) was added thereto. Then, the mixture was stirred to prepare a second sealant 60b in the form of a slurry (or paste).

The first sealant 60a slurry and the second sealant 60b slurry were applied to a space of the positive electrode between a first surface of the solid electrolyte 30 including β-alumina and one surface of the insulator 50 including α-alumina, and to a space of the positive electrode between a second surface of the solid electrolyte, which is in contact with and making an angle with the first surface, and the other surface of the insulator 50, and dried.

The solid electrolyte 30 and the insulator 50 were sealed using the sealant 60 including the first and second sealants 60a and 60b in an electric furnace at about 820° C., and cooled.

### Comparative Example 1

The solid electrolyte 30 and the insulator 50 were sealed in the same manner as in Example 1, except that only the second sealant 60b slurry was used.

### Evaluation Example

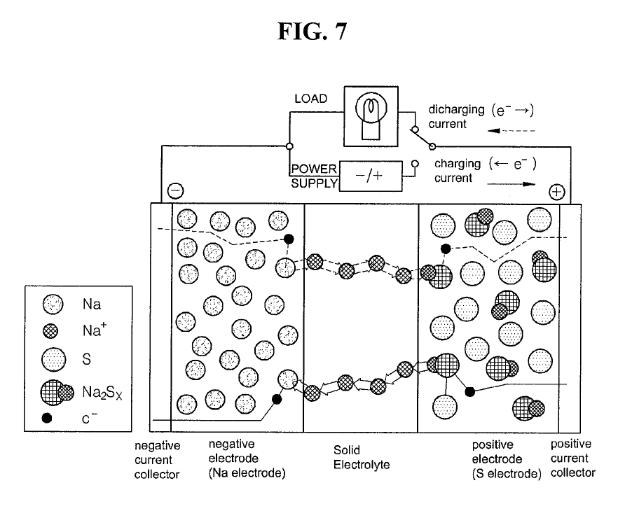

FIG. 8 is an optical microscopic image partially showing the second sealant 60b sealed according to Comparative Example 1.

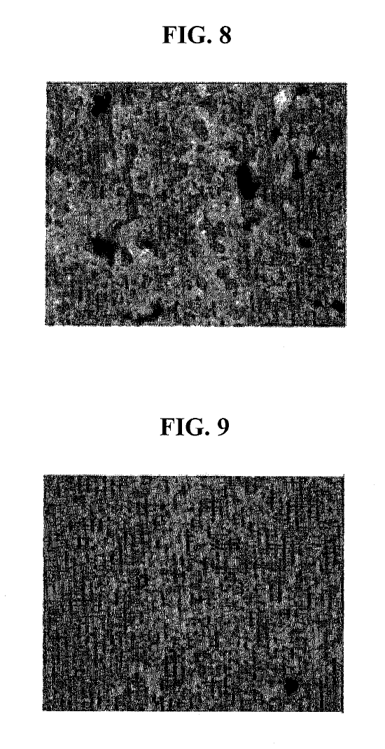

FIG. 9 is an optical microscopic image partially showing the second sealant 60b sealed according to Example 1.

As shown in FIGS. 8 and 9, the second sealant 60b sealed according to Example 1 has better air tightness than the first sealant 60a sealed according to Comparative Example 1.

As described above, according to the one or more of the above embodiments of the present invention, air tightness and adhesive strength between the solid electrolyte 30 and the insulator 50 may be improved in the electrochemical battery using at least two types of sealants having different glass transition temperatures (Tg), respectively.

It should be understood that the exemplary embodiments described therein should be considered in a descriptive sense only and not for purposes of limitation. Descriptions of features or aspects within each embodiment should typically be considered as available for other similar features or aspects in other embodiments.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. An electrochemical battery comprising:
a housing;
a pouch-shaped solid electrolyte in the housing and having an open end;
an insulator on the open end of the solid electrolyte to cover the open end and comprising a plurality of protrusions facing the open end of the solid electrolyte;
at least two types of sealants between the solid electrolyte and the insulator and having different glass transition temperatures, respectively;
a first electrode material inside the pouch-shaped solid electrolyte; and
a second electrode material outside the pouch-shaped solid electrolyte.

2. The electrochemical battery of claim 1, wherein the sealants are disposed between a first surface of the solid electrolyte and one surface of the insulator and between a second surface of the solid electrolyte, which is in contact with and makes an angle with the first surface, and another surface of the insulator.

3. The electrochemical battery of claim 1, wherein a first surface of the solid electrolyte is in contact with one surface of the insulator, and the sealants are disposed between a second surface of the solid electrolyte, which is in contact with and makes an angle with the first surface, and another surface of the insulator.

4. The electrochemical battery of claim 1, wherein the insulator has a ring-shape having a through hole, and a current collector is configured to extend from the insulator to the inside of the solid electrolyte via the through hole.

5. The electrochemical battery of claim 1, wherein the thickness of each of the sealants is in a range of 20 to 700 μm.

6. The electrochemical battery of claim 1, wherein the sealants comprise a first sealant and a second sealant, wherein the glass transition temperature of the first sealant is lower than that of the second sealant.

7. The electrochemical battery of claim 6, wherein the first sealant and the second sealant are aligned to have a stack structure.

8. The electrochemical battery of claim 6, wherein the first sealant comprises a Bi₂O₃—ZnO—B₂O₃—SiO₂ oxide.

9. The electrochemical battery of claim 8, wherein the content of Bi₂O₃ is in the range of 10 to 75 parts by weight based on 100 parts by weight of SiO₂.

10. The electrochemical battery of claim 8, wherein the content of ZnO is in the range of 5 to 50 parts by weight based on 100 parts by weight of SiO₂.

11. The electrochemical battery of claim 8, wherein the content of B₂O₃ is in the range of 25 to 100 parts by weight based on 100 parts by weight of SiO₂.

12. The electrochemical battery of claim 6, wherein the second sealant comprises a SiO₂—CaO—Al₂O₃—B₂O₃ oxide.

13. The electrochemical battery of claim 12, wherein the content of CaO is in the range of 5 to 25 parts by weight based on 100 parts by weight of SiO₂.

14. The electrochemical battery of claim 12, wherein the content of Al₂O₃ is in the range of 5 to 75 parts by weight based on 100 parts by weight of SiO₂.

15. The electrochemical battery of claim 12, wherein the content of B₂O₃ is in the range of 25 to 100 parts by weight based on 100 parts by weight of SiO₂.

16. A method of preparing an electrochemical battery comprising a solid electrolyte and an insulator, the method comprising:
disposing at least two types of sealants having different glass transition temperatures, respectively, between the solid electrolyte and the insulator; and
heat-treating the sealants.

17. The method of claim 16, wherein the heat-treatment is performed at a temperature in a range from 700 to 1000° C.

18. The method of claim 16, further comprising:
preparing a sealant before the disposing of the at least two types of sealants, wherein the sealant is prepared by dissolving a material in a powder form including Bi₂O₃, ZnO, B₂O₃ and SiO₂ in a mixture of a solvent and a binder.

19. The method of claim 16, further comprising:
preparing a sealant before the disposing of the at least two types of sealants, wherein the sealant is prepared by dissolving a material in a powder form including SiO₂, CaO, Al₂O₃ and B₂O₃ in a mixture of a solvent and a binder.

20. The method of claim 16, further comprising:
preparing a first sealant and a second sealant before the disposing of the at least two types of sealants, wherein the first sealant is prepared by dissolving a material in a powder form including Bi₂O₃, ZnO, B₂O₃ and SiO₂ in a mixture of a solvent and a binder, and the second sealant is prepared by dissolving a material in a powder form including SiO₂, CaO, Al₂O₃ and B₂O₃ in a mixture of a solvent and a binder.
